(19) United States
(12) Patent Application Publication
(10) Pub. No.: US 2018/0001898 A1
(43) Pub. Date: Jan. 4, 2018

(54) VEHICLE CONTROL APPARATUS

(71) Applicant: TOYOTA JIDOSHA KABUSHIKI KAISHA, Toyota-shi (JP)

(72) Inventor: Hirotada OTAKE, Susono-shi (JP)

(73) Assignee: TOYOTA JIDOSHA KABUSHIKI KAISHA, Toyota-shi (JP)

(21) Appl. No.: 15/633,095

(22) Filed: Jun. 26, 2017

(30) Foreign Application Priority Data
Jun. 30, 2016 (JP) 2016-130520

(51) Int. Cl. B60W 40/08; B60W 30/09

(52) U.S. Cl. CPC B60W 40/08; B60W 30/09; B60W 2040/0818

(57) ABSTRACT

Driving support ECU outputs an instruction to retract a seatbelt to a seatbelt retracting ECU when a driver of a vehicle is determined to be in an abnormal state where the driver loses an ability to drive the vehicle. Thereby, an upper body of the driver in a weak state is pulled strongly toward a backrest side of a seat. As a result, the driver's upper body is prevented from falling and covering a steering wheel, and LKA (traffic lane keeping control) can be performed properly. The driving support ECU decelerates the vehicle at a target deceleration a to stop the vehicle after outputting the instruction to retract the seatbelt.

### TECHNICAL FIELD

The present invention relates to a vehicle control apparatus for coping with a case where a driver of a vehicle has fallen into an abnormal state in which the driver loses an ability to drive the vehicle.

### BACKGROUND ART

An apparatus has conventionally been proposed which determines whether or not a driver has fallen into an abnormal state where the driver loses an ability to drive a vehicle (for example, a drowsy driving state, a mental and physical failure state, and the like), and decelerates the vehicle when the driver is determined to be in such an abnormal state (for example, refer to Japanese Patent Application Laid-Open (kokai) No. 2009-73462.).

It should be noted that hereinafter an “abnormal state where a driver loses an ability to drive a vehicle” is simply also referred to as an “abnormal state” and a “determination whether or not a driver is in the abnormal state” is simply also referred to as an “abnormality determination of a driver”.

### SUMMARY OF THE INVENTION

When the driver has been determined to be in the abnormal state, one possible measure to be taken is, in addition to the deceleration of the vehicle, to stop the vehicle at a safe place by means of a steering control (an automatic steering). For example, the steering control can be performed in such a manner that a traveling position of the own vehicle is kept at a central position of a traffic lane, or the own vehicle is guided to an edge of a road. However, when the driver becomes weak and the driver falls in such a way that the driver's upper body covers a steering wheel, there is a possibility that the steering control cannot be performed properly because of the driver covering the steering wheel.

The steering control is performed by driving an actuator (for example, a motor) provided at a steering mechanism to steer steered wheels. Therefore, if the steering wheel which is coupled to the steering mechanism is fixed by the driver's upper body, the steering wheel is prevented from rotating, and as a result, it becomes impossible to steer the steered wheels.

The present invention is made in order to resolve the problem above. That is, one of objects of the present invention is to make it possible to perform a steering control properly when a driver's abnormal state is detected.

In order to achieve the object above, one feature of a vehicle control apparatus of the present invention lies in that the vehicle control apparatus comprises;

abnormality determination means (10, S12) for determining whether or not a driver of a vehicle is in an abnormal state where the driver loses an ability to drive the vehicle;

steering control means (10, 17b, 60) for performing a steering control of the vehicle so that the vehicle travels to a target position;

driving-control-under-abnormal-state means (10, 30, 40, S15) for performing a decelerating control which is a control to decelerate the vehicle in parallel with the steering control by the steering control means in a case when the driver is determined to be in the abnormal state by the abnormality determination means; and

seatbelt retracting control means (10, 100, 101, S14) for retracting a seatbelt of the driver based on a determination that the driver is in the abnormal state.

In the present invention, the abnormality determination means makes the determination whether or not the driver of the vehicle is in the abnormal state in which the driver loses the ability to drive the vehicle. As described later, the abnormality determination of the driver can be made by means of various methods. For example, the abnormality determination can be made by determining whether or not a state in which the driver does not conduct any operation to drive the vehicle (a state-with-no-driving-operation) continues for more than or equal to a threshold time (a threshold time for the abnormality determination of the driver), or by determining whether or not a state in which the driver does not push a confirmation button even when the driver is urged to push the confirmation button continues for more than or equal to a threshold time, and so on. Alternatively, the abnormality determination can be made by using a so called “driver monitor technique” disclosed in Japanese Patent Application Laid-Open (kokai) No. 2013-152700 and so on.

The steering control means performs the steering control of the vehicle so that the vehicle travels to the target position. For example, the steering control means grasps a shape of a road ahead of the vehicle, and determines a target traveling line based on the road shape. Thereafter, the steering control means calculates steering control amounts for making the vehicle travel along the target traveling line, and controls steering of steered wheels with the steering control amounts.

The driving-control-under-abnormal-state means performs a decelerating control which is a control to decelerate the vehicle in parallel with the steering control by the steering control means in a case when the driver is determined to be in the abnormal state by the abnormality determination means. For example, the driving-control-under-abnormal-state means decelerates the vehicle until a speed thereof decreases to zero. Therefore, it is possible to make the vehicle stop at a safe place by means of the steering control and the decelerating control. In this case, for example, the steering control means may change the target traveling line depending on whether or not the driver is determined to be in the abnormal state or not. For example, when the driver is determined to be in the abnormal state, the steering control means may extract a retreating place such as an edge of a road from a scenery ahead of the vehicle, calculates the steering control amounts to make the vehicle stop at the retreating place, and control the steering of the steered wheels with the steering control amounts.

Now, when the driver becomes weak and the driver falls in such a way that the driver's upper body covers a steering wheel, there is a possibility that the driver's body interferes with rotation of the steering wheel, and as a result, it becomes impossible to perform the steering control properly. In order to resolve this problem, the present invention comprises the seatbelt retracting control means.

The seatbelt retracting control means retracts the seatbelt of the driver based on the determination that the driver is in the abnormal state. “Retracting a seatbelt” means that increasing a tension of the seatbelt, that is, increasing a force to pull the driver's upper body toward a backrest side of a seat by the seatbelt. Therefore, by retracting the seatbelt, the upper body of the driver in a weak state is pulled strongly toward the backrest side of the seat. Thereby, a posture of the driver is straightened, and the upper body is prevented from covering the steering wheel.

As a result, according to the present invention, the steering control can be performed properly and the vehicle can be stopped at a safe place when the driver's abnormal state is detected. In addition, retracting of the seatbelt serves as an aid to wake up the driver who has temporarily fallen into the abnormal state such as a state of falling asleep.

It should be noted that when the abnormality determination means is configured to make a temporary determination at a preliminary step before the aforementioned determination is confirmed, the determination that the driver is in the abnormal state may include the temporary determination. In this case, for example, the seatbelt retracting control means is preferred to be configured to retract the seatbelt based on the temporary determination that the driver is in the abnormal state. In addition, it is sufficient that the driving-control-under-abnormal-state means performs the decelerating control at least when the determination that the driver is in the abnormal state is confirmed, and therefore the decelerating control may be performed from a point in time at which the temporary determination that the driver is in the abnormal state has been made.

One feature of another aspect of the present invention lies in that;

the abnormality determination means is configured to cancel a determination that the driver is in the abnormal state (S11) in a case when an input to a steering wheel is detected (S23: Yes, S34: Yes) after the driver is determined to be in the abnormal state (S22, S26).

For example, when the driver who was determined to be in the abnormal state is estimated to be back to a normal state (be back to a state where the driver has an ability to drive the vehicle), the determination that the driver is in the abnormal state is canceled, and therefore the decelerating control by the driving-control-under-abnormal-state means can be stopped.

In another aspect of the present invention, the abnormality determination means cancels the determination that the driver is in the abnormal state when the input to the steering wheel is detected after the driver is determined to be in the abnormal state. That is, the abnormality determination means determines whether or not there is the input to the steering wheel, and when the input to the steering wheel is detected, the abnormality determination means estimates that the driver has operated the steering wheel, and cancels the determination that the driver is in the abnormal state.

For example, the abnormality determination means is preferred to be configured to determine that the driver is in the abnormal state when a state in which the driver does not perform any driving operation continues for more than or equal to a predetermined time, and thereafter to cancel the determination that the driver is in the abnormal state when some driving operation including the input to the steering wheel is detected.

Now, when the abnormality determination means is configured to cancel the determination that the driver is in the abnormal state in a case when the input to the steering wheel is detected, if the vehicle control apparatus did not comprise the seatbelt retracting control means, the following new problem arises as described below.

For example, when the upper body of the driver who is in the weak state falls and covers the steering wheel after the driver is determined to be in the abnormal state, a torque is input to the steering wheel. When this torque input to the steering wheel is detected, the abnormality determination means estimates that the driver has operated the steering wheel, and cancels the determination that the driver is in the abnormal state. Therefore, the determination is canceled in spite of the driver's abnormal state actually continuing. This problem is likely to occur especially when the decelerating control of the vehicle is performed since the driver's upper body leans forward due to the deceleration.

In contrast, in the present invention, the seatbelt retracting control means retracts the seatbelt of the driver based on the determination result that the driver is in the abnormal state, and therefore the driver's upper body is prevented from falling and covering the steering wheel after the driver is determined to be in the abnormal state. Thereby, when the input to the steering wheel has been detected after the driver is determined to be in the abnormal state, it is possible to correctly estimate that the operation detected is the steering operation by the driver. Therefore, the accuracy of the abnormality determination by the abnormality determination means can be improved.

One feature of another aspect of the present invention lies in that;

the abnormality determination means is configured to;
make a temporary determination (S22) that the driver is in the abnormal state when a state-with-no-driving-operation in which any driving operation by the driver is not detected continues for more than or equal to a temporary abnormality determination time; and
cancel the temporary determination (S11) when a driving operation by the driver is detected (S23: Yes) after the temporary determination is made, while confirm a determination that the driver is in the abnormal state (S26) when the state-with-no-driving-operation has continued until an abnormality confirmation condition (S24) set in advance is satisfied without the temporary determination being canceled,

the seatbelt retracting control means is configured to retract the seatbelt of the driver (S14) based on the temporary determination that the driver is in the abnormal state, and

the driving-control-under-abnormal-state means is configured to decelerate the vehicle (FIG. 3: S15) after the determination that the driver is in the abnormal state is confirmed.

In another aspect of the present invention, the abnormality determination means makes the temporary determination that the driver is in the abnormal state when the state-with-no-driving-operation in which any driving operation by the driver is not detected continues for more than or equal to the temporary abnormality determination time. That is, the abnormality determination means detects the state-with-no-driving-operation based on whether or not there is an operation of a driving operator operated by the driver, and makes the temporary determination that the driver is in the abnormal state when this state-with-no-driving-operation continues for more than or equal to the temporary abnormality determination time.

The seatbelt retracting control means retracts the seatbelt of the driver based on the temporary determination that the driver is in the abnormal state. Thereby, the driver's posture is straightened.

The driver's posture is straightened after the seatbelt is retracted. Therefore, when the driving operation by the driver has been detected, it can be estimated that the driving operation has been performed by the driver's intention. In this case, the abnormality determination means cancels the temporary determination that the driver is in the abnormal state. On the contrary, when the state-with-no-driving-operation continues even after the seatbelt was retracted, it can be estimated that the temporary determination that the driver is in the abnormal state is correct. Therefore, the abnormality determination means confirms the determination that the driver is in the abnormal state when the state-with-no-driving-operation has continued until the abnormality confirmation condition set in advance is satisfied without the temporary determination being canceled. For example, the abnormality determination means confirms the determination that the driver is in the abnormal state when the state-with-no-driving-operation continues for more than or equal to an abnormality confirmation time set in advance without the temporary determination being canceled.

The driving-control-under-abnormal-state means decelerates the vehicle after the determination that the driver is in the abnormal state is confirmed. Therefore, the vehicle can be decelerated based on the abnormality determination result with high accuracy. In addition, the seatbelt can be retracted before the driver leans forward due to the deceleration of the own vehicle, and thus the retraction of the seatbelt can be performed properly. Further, the steering control can be performed properly by retracting the seatbelt.

One feature of another aspect of the present invention lies in that;

the abnormality determination means is configured to;
make a temporary determination (S22) that the driver is in the abnormal state when a state-with-no-driving-operation in which any driving operation by the driver is not detected continues for more than or equal to a temporary abnormality determination time; and
cancel the temporary determination (S11) when a driving operation by the driver is detected (S23: Yes) after the temporary determination is made, while confirm a determination that the driver is in the abnormal state (S26) when the state-with-no-driving-operation has continued until an abnormality confirmation condition (S32) set in advance is satisfied without the temporary determination being canceled,

the seatbelt retracting control means is configured to retract the seatbelt of the driver (S14) based on the temporary determination that the driver is in the abnormal state, and

the driving-control-under-abnormal-state means is configured to;
decelerate the vehicle at a first target deceleration (S31) when the temporary determination that the driver is in the abnormal state is made; and
switch a target deceleration of the vehicle to a second target deceleration, an absolute value of which is greater than an absolute value of the first target deceleration to decelerate the vehicle at the second target deceleration (S33) when the determination that the driver is in the abnormal state is confirmed.

In another aspect of the present invention, the abnormality determination means makes the temporary determination that the driver is in the abnormal state when the state-with-no-driving-operation in which any driving operation by the driver is not detected continues for more than or equal to a temporary abnormality determination time. The seatbelt retracting control means retracts the seatbelt of the driver based on the temporary determination that the driver is in the abnormal state. Accordingly, the driver's posture is straightened. Besides, the driving-control-under-abnormal-state means decelerate the vehicle at the first target deceleration when the temporary determination that the driver is in the abnormal state is made. By decelerating the vehicle as stated above, it is possible to urge the driver to perform some driving operation. In addition, it is possible to decelerate the vehicle to a safe speed. It is preferable that this first target deceleration is set to be a very moderate deceleration (a deceleration, an absolute value thereof is small).

When the driving operation by the driver has been detected after the seatbelt was retracted, it can be estimated that the driving operation has been performed by the driver's intention. In this case, the abnormality determination means cancels the temporary determination that the driver is in the abnormal state. On the contrary, when the state-with-no-driving-operation continues even after the seatbelt was retracted, it can be estimated that the temporary determination that the driver is in the abnormal state is correct.

Therefore, the abnormality determination means confirm the determination that the driver is in the abnormal state when the state-with-no-driving-operation has continued until the abnormality confirmation condition set in advance is satisfied without the temporary determination being canceled. For example, the abnormality determination means confirms the determination that the driver is in the abnormal state when the vehicle speed becomes less than or equal to an abnormality confirmation speed set in advance without the temporary determination being canceled, or when the state-with-no-driving-operation continues for more than or equal to the abnormality confirmation time set in advance without the temporary determination being canceled.

The driving-control-under-abnormal-state means switches the target deceleration of the vehicle to the second target deceleration, the absolute value of which is greater than the absolute value of the first target deceleration to decelerate the vehicle at the second target deceleration when the determination that the driver is in the abnormal state is confirmed. Therefore, it is possible to stop the vehicle at a safe place early at a stage where the accuracy of the abnormality determination is increased. Besides, the steering control can be performed properly by retracting the seatbelt.

Further, the retraction of the seatbelt can be performed before the vehicle is decelerated at the first target deceleration, or while the vehicle is being decelerated at the first target deceleration. That is, the seatbelt can be retracted before the vehicle is decelerated at the second target deceleration, and therefore the seatbelt can be retracted properly.

One feature of another aspect of the present invention lies in that;

the vehicle control apparatus comprises a seatbelt loosening control means (10, 100, 101, S17) for loosening the retracted seatbelt when the vehicle is made to stop by the driving-control-under-abnormal-state means.

In another aspect of the present invention, the seatbelt loosening control means loosens the retracted seatbelt when the he vehicle is made to stop by the driving-control-under-abnormal-state means. Therefore, the driver is easy to be rescued because the seatbelt has been loosened at a time of being rescued. Hence, it is possible to rescue the driver at an early timing.

In the above description, references used in the following descriptions regarding embodiments are added with parentheses to the elements of the present invention, in order to assist in understanding the present invention. However, those references should not be used to limit the scope of the invention.

### BRIEF DESCRIPTION OF THE DRAWINGS

FIG. 1 is a schematic configuration diagram of a vehicle control apparatus according to an embodiment of the present invention.

FIG. 2 is a flowchart showing a driving support control routine under an abnormal state of a first embodiment.

FIG. 3 is a flowchart showing a driving support control routine under an abnormal state of a second embodiment.

FIG. 4 is a flowchart showing a driving support control routine under an abnormal state of a third embodiment.

FIG. 5 is a plan view showing a left white line, a right white line, a target traveling line, and a curve radius.

FIG. 6 is a diagram for describing a traffic lane keeping control.

### DESCRIPTION OF THE EMBODIMENT

A vehicle control apparatus according to an embodiment of the present invention will be described below, referring to figures.

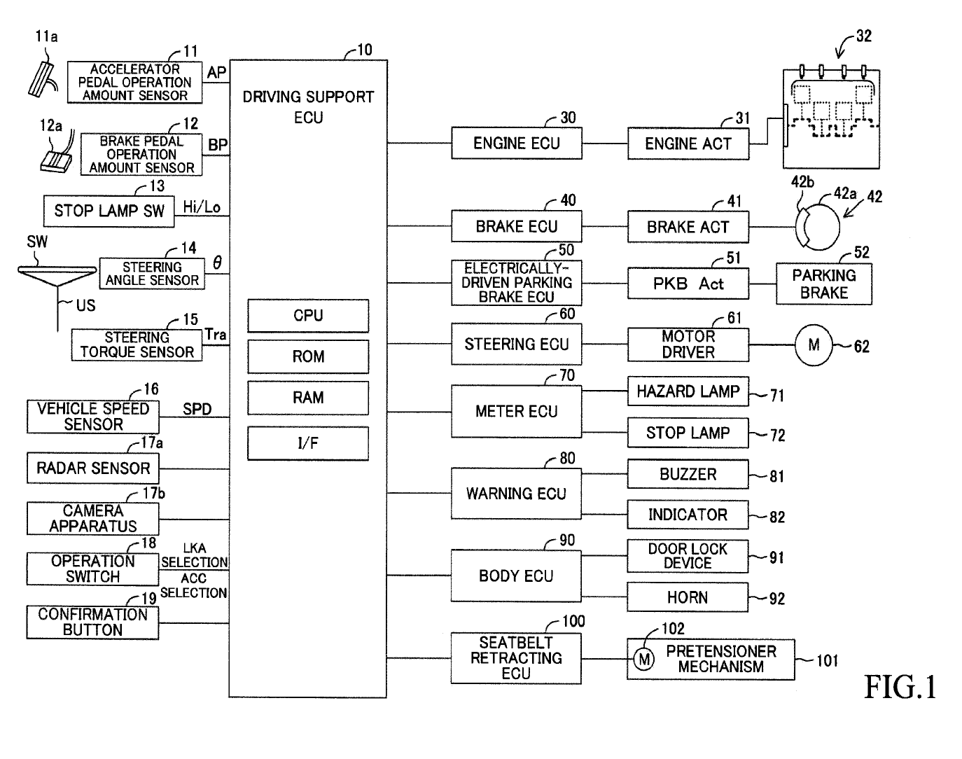

A vehicle control apparatus according to the embodiment of the present invention is, as shown in FIG. 1, applied to a vehicle (hereinafter, may be referred to as an “own vehicle” in order to distinguish it from other vehicles), and comprises a driving support ECU 10, an engine ECU 30, a brake ECU 40, an electrically-driven parking brake ECU 50, a steering ECU 60, a meter ECU 70, a warning ECU 80, a body ECU 90, and a seatbelt retracting ECU 100. Hereinafter, the driving support ECU 10 will be referred to as a “DSECU 10”.

Each of the ECUs is an electric control unit comprising a microcomputer as a main part. Those ECUs are connected via CAN (Controller Area Network) which is not illustrated so that the ECUs are capable of mutually transmitting and receiving information. In the present specification, the microcomputer includes CPU, ROM, RAM, a non-volatile memory, an interface I/F, or the like. The CPU is configured to realize/perform various functions by executing instructions (i.e., programs or routines) stored in the ROM. Some of those ECUs or all of those ECUs may be integrated into one ECU.

The DSECU 10 is connected to sensors (including switches) listed below, and is configured to receive a detection signal or an output signal of these sensors. It should be noted that each sensor may be connected to ECUs other than the DSECU 10. In this case, the DSECU 10 receives the detection signal or the output signal of the sensor via CAN from the ECU to which the sensor is connected.

An accelerator pedal operation amount sensor 11 is configured to detect an operation amount (an accelerator position) of an accelerator pedal 11a of the own vehicle, and to output a signal representing the accelerator pedal operation amount AP.

A brake pedal operation amount sensor 12 is configured to detect an operation amount of a brake pedal 12a of the own vehicle, and to output a signal representing the brake pedal operation amount BP.

A stop lamp switch 13 is configured to output a low level signal when the brake pedal 12a is not being depressed (is not being operated), and to output a high level signal when the brake pedal 12a is being depressed (is being operated).

A steering angle sensor 14 is configured to detect a steering angle of the own vehicle, and to output a signal representing the steering angle θ.

A steering torque sensor 15 is configured to detect a steering torque added to a steering shaft US of the own vehicle by an operation of a steering wheel SW, and to output a signal representing the steering torque Tra.

A vehicle speed sensor 16 is configured to detect a traveling speed (a vehicle speed) of the own vehicle, and to output a signal representing the vehicle speed SPD.

A radar sensor 17a is configured to obtain information regarding a road ahead of the own vehicle, and a three-dimensional object present in the road. The three-dimensional object includes, for example, moving objects such as a pedestrian, a bicycle and an automobile, and static objects such as a power pole, a tree, and a guardrail. Hereinafter, these three-dimensional objects may be referred to as a “target object.”

The radar sensor 17a comprises a “radar transmission/reception part and a signal processor”, both of which are not illustrated.

The radar transmission/reception part emits an electric wave in a millimeter waveband (hereinafter, referred to as a “millimeter wave”) to an ambient region of the own vehicle including a front region of the own vehicle, and receives a millimeter wave (i.e., a reflected wave) reflected from a target object which is present in the emitted area.

The signal processor obtains, every predetermined period of time, an inter-vehicle distance (a longitudinal distance), a relative speed, a lateral distance, a relative lateral speed, and the like, with respect to each detected target object based on a phase difference between the transmitted millimeter wave and the received reflected wave, an attenuation level of the reflected wave, a time from a point in time of transmitting the millimeter wave to a point in time of receiving the reflected wave, or the like.

A camera apparatus 17b comprises a “stereo camera and an image processor”, both of which are not illustrated.

The stereo camera photographs/captures landscapes of a left-side region and a right-side region in front of the own vehicle to obtain a left-and-right pair of image data.

The image processor is configured to calculate information as to whether or not a target object is present, a relative relationship between the own vehicle and the target object and the like, based on the left-and-right pair of image data photographed/captured by the stereo camera to output them.

It should be noted that the DSECU 10 is configured to determine a relative relationship (target object information) between the own vehicle and the target object by composing the relative relationship between the own vehicle and the target object obtained by the radar sensor 17a and the relative relationship between the own vehicle and the target object obtained by the camera apparatus 17b. Further, the DSECU 10 is configured to recognize a lane marker such as a left white line and a right white line of a road (hereinafter, simply referred to as a “white line”) based on the left-and-right pair of image data (road image data) photographed/captured by the camera apparatus 17b and to obtain a shape of the road (a curvature radius representing a degree of how much the road is curved), a positional relationship between the road and the own vehicle, and the like. In addition, the DSECU 10 is configured to also obtain the information whether or not a road side wall exists based on the image data photographed/captured by the camera apparatus 17b.

An operation switch 18 is a switch to be operated by a driver. The driver can select whether or not to perform a traffic lane keeping control (LKA: Lane Keeping Assist control) by operating the operation switch 18. Moreover, the driver can select whether or not to perform a trailing inter-vehicle distance control (ACC: Adaptive Cruise Control) by operating the operation switch 18.

A confirmation button 19 is arranged at a position capable of being operated by the driver. The confirmation button 19 is configured to output a low-level signal when not being operated and to output a high-level signal when being pressed.

The DSECU 10 is configured to perform the LKA and the ACC. Further, as described later, the DSECU 10 is configured to determine whether or not the driver is in an abnormal state in which the driver loses an ability to drive the vehicle, and to perform various types of control to perform appropriate processes when the driver is determined to be in the abnormal state.

The engine ECU 30 is connected to an engine actuator 31. The engine actuator 31 includes actuators for changing a driving state of an internal combustion engine 32. In the present embodiment, the internal combustion engine 32 is a gasoline fuel injection, spark ignition, multi-cylinder engine, and comprises a throttle valve to adjust an intake air amount. The engine actuator 31 includes at least a throttle valve actuator to change an opening degree of the throttle valve. The engine ECU 30 can change torque which the internal combustion engine 32 generates by driving the engine actuator 31. The torque which the internal combustion engine 32 generates is transmitted to a non-illustrated driving wheels via a non-illustrated transmission gear. Therefore, the engine ECU 30 can control the engine actuator 31 to control a driving force of the own vehicle, so as to change an acceleration state (an acceleration rate).

The brake ECU 40 is connected to a brake actuator 41. The brake actuator 41 is provided in a hydraulic circuit between a non-illustrated master cylinder to compress operating fluid with a depression force of the brake pedal and friction brake mechanisms 42 provided at left-and-right-front wheels and left-and-right-rear wheels. Each of the friction brake mechanisms 42 comprises a brake disc 42a fixed to the wheel and a brake caliper 42b fixed to a vehicle body. The brake actuator 41 adjusts, in response to an instruction from the brake ECT 40, a hydraulic pressure that is supplied to a wheel cylinder which is built in the brake caliper 42, and operates the wheel cylinder with the hydraulic pressure. Thereby, the brake actuator 41 presses a brake pad onto the brake disc 42a to generate a friction braking force. Accordingly, the brake ECU 40 can control the braking force of the own vehicle by controlling the brake actuator

The electrically-driven parking brake ECU (hereinafter, may be referred to as an “EPB ECU”) 50 is connected to a parking brake actuator (hereinafter, may be referred to as a “PKB actuator”) 51. The PKB actuator 51 is an actuator for pressing the brake pad onto the brake disc 42a or for, in a case when comprising a drum brake, pressing a shoe onto a drum rotating with the wheel. Therefore, EPB ECU 50 can add a parking brake force to the wheel by means of the PKB actuator 51 to maintain the vehicle in a stopped state.

The steering ECU 60 is a control apparatus of a well-known electrically-driven power steering system and is connected to a motor driver 61. The motor driver 61 is connected to a steering motor 62. The steering motor 62 is incorporated into a non-illustrated “steering mechanism including the steering wheel, the steering shaft coupled to the steering wheel, a gear mechanism for steering, and the like” of the vehicle. The steering motor 62 generates torque with electric power supplied from the motor driver 61 to be able to add a steering assist torque using the torque, or to turn left-and-right steered wheels.

The meter ECU 70 is connected to a non-illustrated digital indication type meter and is also connected to a hazard lamp 71 and a stop lamp 72. The meter ECU 70 can, in response to an instruction from the DSECU 10, make the hazard lamp 71 blink and make the stop lamp 72 light.

The warning ECU 80 is connected to a buzzer 81 and an indicator 82. The warning ECU 80 can, in response to an instruction from the DSECU 10, make the buzzer 81 sound to alert the driver, make a mark for alerting (for example, a warning lamp) light on the indicator 82, display a warning message on the indicator 82, and display an operating state of a driving support control on the indicator 82.

The body ECU 90 is connected to a door lock device 91 and a horn 92. The body ECU 90 can unlock the door lock device 91 in response to an instruction from the DSECU 10. In addition, the body ECU 90 can make the horn 92 sound in response to an instruction from the DSECU 10.

The seatbelt retracting ECU 100 is connected to a retracting motor 102. The retracting motor 102 is an electrically-driven motor and is assembled in a pretensioner mechanism. The pretensioner mechanism 101 is a mechanism to retract an webbing of a seatbelt, and comprises the retracting motor 102, a spool to retract the seatbelt, a gear mechanism to transmit a rotation of the retracting motor 102 to the spool, and a lock mechanism to lock the seatbelt so that the seatbelt is not pulled out.

The pretensioner mechanism 101 is known and the one disclosed in Japanese Patent Application Laid-Open (kokai) No. 2011-168215 can be used, for example. In general, the pretensioner mechanism 101 is provided for a purpose of improving an occupant protective performance in collision. In the present embodiment, when the driver is determined to be in the abnormal state, a posture of the driver is straightened by using this pretensioner mechanism 101 so that the upper body of the driver does not cover the steering wheel SW, as described later.

The seatbelt retracting ECU 100 retracts the seatbelt by positively rotating the retracting motor 102 when an instruction to retract the seatbelt is input from the DSECU 10. In the pretensioner mechanism 101, the seatbelt is locked under a state where the seatbelt is retracted by means of the lock mechanism. Accordingly, the driver can be fixed in a right posture by pulling the driver's upper body toward a backrest side of a seat. In addition, the seatbelt retracting ECU 100 unlocks and weakens a tension of the seatbelt by reversely rotating the retracting motor 102 after positively rotating the retracting motor 102 when an instruction to loosen the seatbelt is input from the DSECU 10. It should be noted that the pretensioner mechanism 101 may be provided in at least the seatbelt of a driver's seat.

### <Control Processes Performed by the DSECU 10>

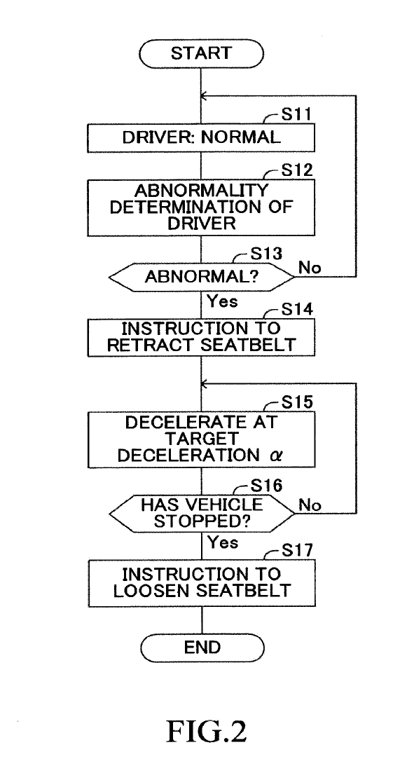

Next, control processes performed by the DSECU 10 will be explained. The DSECU 10 performs a driving support control routine under the abnormal state (FIG. 2) which will be described later when both of the traffic lane keeping control (LKA) and the trailing inter-vehicle distance control (ACC) are being performed. Therefore, the traffic lane keeping control and the trailing inter-vehicle distance control will be described first.

### <Traffic Lane Keeping Control (LKA)>

The traffic lane keeping control (hereinafter, referred to as “LKA”) is a control to support a steering operation of the driver by adding the steering torque to the steering mechanism so that a position of the own vehicle is kept nearby (in the vicinity of) a target traveling line in a “lane on which the own vehicle is traveling (a traveling lane)”. The LKA itself is well known (for example, refer to Japanese Patent Applications Laid-Open (kokai) No. 2008-195402, No. 2009-190464, No. 2010-6279, and Japanese Patent No. 4349210, and so on.). Therefore, a simple description will next be made below.

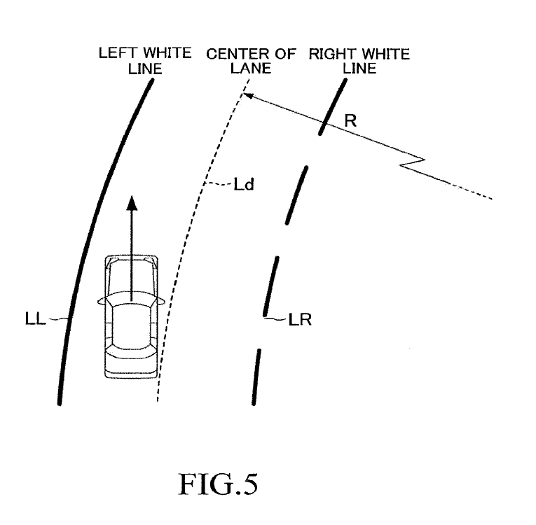

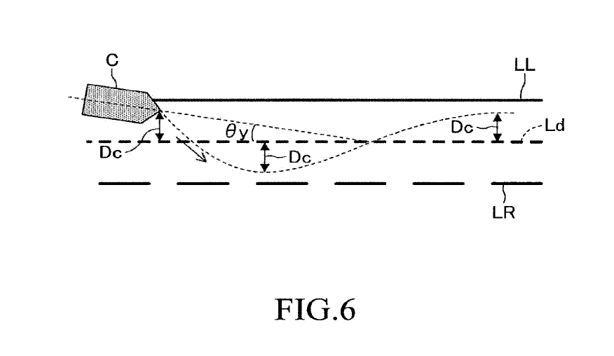

The DSECU 10 performs the LKA when the LKA is being requested by the operation of the operation switch 18. More specifically, as shown in FIG. 5, the DSECU 10 recognizes (obtains) “the left white line LL and the right white line LR” of the lane on which the own vehicle is traveling based on the image data transmitted from the camera apparatus 17b when the LKA is being requested, and determines a central position of a pair of these white lines to be a target traveling line Ld. In addition, the DSECU 10 calculates a curve radius (a curvature radius) R of the target traveling line Ld, and a position and a direction of the own vehicle in a traveling line defined by the left white line LL and the right white line LR. Then, as shown in FIG. 6, the DSECU 10 calculates a distance Dc (hereinafter, referred to as a “center distance Dc”) in a width direction of a road between a central position of a front end of the own vehicle C and the target traveling line Ld, and a deviation angle θy (hereinafter, referred to as a “yaw angle θy”) between a direction of the target traveling line Ld and the traveling direction of the own vehicle.

Further, the DSECU 10 calculates a target steering angle θ* using the following formula (1) based on the center distance Dc, the yaw angle θy, and a road curvature v(=1/curvature radius R) every time a predetermined calculation interval elapses. In the formula (1), K1, K2 and K3 are control gains. The target steering angle θ* is a steering angle set so that the own vehicle can travel along the target traveling line Ld.

θ*=K1×v+K2×θy+K3×Dc (1)

The DSECU 10 outputs an instruction signal representing this target steering angle θ* to the steering ECU 60. The steering ECU 60 drives and controls the steering motor 62 so that the steering angle θ matches (coincides with) the target steering angle θ*.

It should be noted that the LKA is a control that only assists driving by the driver so that the own vehicle travels along the target traveling line Ld. Therefore, “driving without holding the steering wheel” is not allowed even when the LKA is being performed, and thus the driver is required to hold the steering wheel. The above description is a summary of the LKA.

A function part of the DSECU 10 which performs the LKA stated above corresponds to the steering control means of the present invention.

### <Trailing Inter-Vehicle Distance Control (ACC)>

The trailing inter-vehicle distance control (hereinafter, referred to as “ACC”) is a control to make the own vehicle trail the preceding vehicle traveling right ahead the own vehicle, while keeping the inter-vehicle distance between the preceding vehicle and the own vehicle to be/at a predetermined distance. The ACC itself is well known (for example, refer to Japanese Patent Applications Laid-Open (kokai) No. 2014-148293 and No. 2006-315491, and Japanese Patents No. 4172434, and No. 4929777 and so on.) Therefore, a simple description will be made below.

The DSECU 10 performs the ACC in a case when the ACC is being requested by the operation of the operation switch 18.

More specifically, the DSECU 10 selects a trailing target vehicle (i.e., a trailing objective vehicle) based on the target object information obtained by the radar sensor 17a and the camera apparatus 17b in a case when the ACC is being requested. For example, the DSECU 10 determines whether or not a relative position of the target object (n) identified by the lateral distance Dfy(n) and the inter-vehicle distance Dfx(n) of the detected target object (n) exists (or, is present) in a trailing target vehicle area which is set in advance so as to have a lateral length that becomes smaller as the inter-vehicle distance becomes larger. Thereafter, when the relative position of the target object exists (or, is present) in the trailing target vehicle area for more than or equal to a predetermined time, the DSECU 10 selects the target object (n) as the trailing target vehicle.

Further, the DSECU 10 calculates a target acceleration Gtgt using either a formula (2) or a formula (3) below. In the formula (2) and the formula (3), a Vfx(a) is a relative speed of the trailing target vehicle (a), k1 and k2 are predetermined positive gains (coefficients), and ΔD1 is an inter-vehicle deviation obtained by subtracting a “target inter-vehicle distance Dtgt” from an “inter-vehicle distance Dfx(a) of the trailing target vehicle (a)” (=Dfx(a)−Dtgt). It should be noted that the target inter-vehicle distance Dtgt is calculated by multiplying a target inter-vehicle time Ttgt which is set by the driver by using the operation switch 18 by the vehicle speed SPD of the own vehicle (that is, Dtgt=Ttgt×SPD).

The DSECU 10 determines the target acceleration Gtgt by using (in accordance with) the following formula (2) in a case when the value (k1×ΔD1+k2×Vfx(a)) is positive or “0”. Ka1 is a positive gain (coefficient) for an acceleration and is set to be a value less than or equal to be “1”.

The DSECU 10 determines the target acceleration Gtgt by using (in accordance with) the following formula (3) in a case when the value (k1×ΔD1+k2×Vfx(a)) is negative. Kd1 is positive a gain (coefficient) for a deceleration and is set to be “1” in the present embodiment.

Gtgt(for the acceleration)=ka1×(k1×ΔD1+k2×Vfx(a)) (2)

Gtgt(for the deceleration)=kd1×(k1×ΔD1+k2×Vfx(a)) (3)

It should be noted that in a case when the target object does not exist (or not be present) in the trailing target vehicle area, the DSECU 10 determines the target acceleration Gtgt based on a “target speed which is set depending on the target inter-vehicle time Ttgt” and the vehicle speed SPD, in such a manner that the vehicle speed SPD matches with (becomes equal to) the target speed.

The DSECU 10 controls the engine actuator 31 through the engine ECU 30, and when needed, controls the brake actuator 41 through the brake ECU 40 in such a manner that the acceleration of the own vehicle matches with the target acceleration Gtgt.

<Driving Support Control Routine under the Abnormal State>

Next, a process of the driving support control under the abnormal state performed by the DSECU 10 will be described. FIG. 2 shows a driving support control routine under the abnormal state performed by the DSECU 10. The DSECU 10 performs the driving support control routine under the abnormal state in parallel with performances of both of the AKA and the ACC.

When the driving support control routine under the abnormal state is activated, the DSECU 10 sets the driver's state to “normal” at a step S11. In this driving support control routine under the abnormal state, processes to be performed are determined in accordance with the driver's state. However, the driver's state has not been set at a time of activation. Therefore, in this step S11, the driver's state is set to “normal”. That is, the process of the step S11 serves also as an initial setting.

Subsequently, the DSECU 10 makes a determination (hereinafter, refer to an “abnormality determination”) at a step S12 whether the driver is in a normal state or in the abnormal state. Various methods can be adopted as this abnormality determination of the driver.

For example, the following method can be adopted in which the driver is determined to be in a normal state when a state where any driving operation by the driver is not performed (a state-with-no-driving-operation) does not continue for more than or equal to a threshold time (a driver abnormality determination time) whereas the driver is determined to be in the abnormal state when the state-with-no-driving-operation continues for more than or equal to the threshold time.

The state-with-no-driving-operation is a state where any of parameters consisting of one or more combinations of “the accelerator pedal operation amount AP, the brake pedal operation amount BP, the steering torque Tra, and a signal level of the stop lamp switch 13” which vary depending on the operation by the driver (the input to a driving operator) does not change. In the present embodiment, the DSECU 10 regards a state where any of “the accelerator pedal operation amount AP, the brake pedal operation amount BP, and the steering torque Tra” does not change as well as the steering torques remains “0” as the state-with-no-driving-operation.

A duration time of the state-with-no-driving-operation can be measured by determining whether or not a state is the state-with-no-driving-operation every time a predetermined calculation interval elapses, incrementing a value of a timer when the state-with-no-driving-operation is detected, and clearing the value of the timer to zero when some driving operation is detected. In this case, the driver is determined to be in the abnormal state when the value of the timer has reached the driver abnormality determination time.

As another example of the abnormality determination method of the driver, a so-called “driver monitor technique” which is disclosed in Japanese Patent Application Laid-Open (kokai) No. 2013-152700 and the like may be used. More specifically, a camera for photographing a driver is provided on an interior member of a vehicle (for example, a steering wheel, a pillar, and the like). The DSECU 10 monitors a direction of a driver's line of sight or a driver's face direction using the photographed image by the camera. The DSECU 10 determines that the driver is in the abnormal state when the driver's line of sight or the driver's face direction has been in a certain direction for more than or equal to a predetermined time, wherein the certain direction is a direction to which the driver's line of sight or the driver's face direction does not face while driving normally.

As another example of the abnormality determination method of the driver, the confirmation button 19 may be used. More specifically, the DSECU 10 urges the driver to operate the confirmation button 19 by an indication and/or a sound every time a first time elapses, and determines that the driver is in the abnormal state when a state in which the confirmation button 19 is not operated has continued for more than or equal to a second time which is longer than the first time.

Other than these methods, arbitrary methods can be adopted as the abnormality determination of the driver.

It should be noted that the DSECU 10 may raise a warning to urge the driver to perform some driving operation in the midst of determining whether or not the driver is in the abnormal state. The DSECU 10 may determine that the driver is in the abnormal state when a state in which the driver is suspected to be in the abnormal state (for example, the state-with-no-driving-operation) continues in spite of raising the warning. For example, the DSECU 10 outputs a no-driving-operation warning instruction to the warning ECU 80 when the duration time of the state-with-no-driving-operation has reached a warning start time which is set to be shorter than the driver abnormality determination time. Accordingly, the warning ECU 80 makes a warning sound from the buzzer 81, makes a warning lamp blink on the indicator 82, and displays a warning message urging the driver to operate any one of “the accelerator pedal 11a, the brake pedal 12a, and the steering wheel SW”.

Now, come back to FIG. 2 and restart the description of the driving support control routine under the abnormal state. After the DSECU 10 makes the driver's abnormality determination at the step S12 as stated above, the DSECU 10 proceeds to a step S13 and determines whether or not the driver is in the abnormal state. When the driver is not in the abnormal state (S13: No), the DSECU 10 proceeds back to the step S11. The DSECU 10 repeatedly performs such processes every time a predetermined calculation interval elapses.

As a result of repeating the processes above, when the driver's abnormal state has been detected, that is, when the driver has been determined to be in the abnormal state where the driver loses the ability to driver the vehicle (S13: Yes), the DSECU 10 proceeds to a step S14. The DSECU 10 outputs, at the step S14, an instruction to retract the seatbelt to the seatbelt retracting ECU 100. Accordingly, the seatbelt retracting ECU 100 retracts the seatbelt by positively rotating the retracting motor 102. As a result, the driver's upper body is pulled toward the backrest side of the seat, and the driver is fixed in the right posture. This seatbelt retraction is applied to the seatbelt of the driver's seat.

The driving support control routine under the abnormal state is performed in parallel with the aforementioned LKA. When the LKA is performed, the steering motor 62 is driven, and left and right steered wheels are steered. Now, the steering wheel SW is mechanically coupled to the steered wheels via the steering shaft, the gear mechanism, a coupling arm, and the like, and therefore the steering wheel SW rotates along with the steering of the steered wheels. Thus, when the driver becomes weak and the driver's upper body falls and covers the steering wheel SW, there is a possibility that the driver's body interferes with the rotation of the steering wheel SW and that the steering control of the LKA cannot be performed properly.

Therefore, the DSECU 10 straightens, at the step S14, the driver's posture by retracting the seatbelt so that the driver does not fall and cover the steering wheel SW. Accordingly, the steering control of the LKA can be performed properly also after performing the process of the step S14.

Subsequently, the DSECU 10, at a step S15, stops the ACC and decelerates the own vehicle at a constant target deceleration a set in advance. In this case, the DSECU 10 calculates an acceleration of the own vehicle from a change amount of the vehicle speed SPD per unit time obtained based on the signal from the vehicle speed sensor 16, and outputs to the engine ECU 30 and the brake ECU 40 an instruction signal for matching the acceleration thereof with the target deceleration a. Accordingly, the own vehicle can be decelerated at the constant target deceleration a. It should be noted that when there is a possibility that the inter-vehicle distance between the own vehicle and a preceding vehicle traveling in front of the own vehicle becomes less than a permissible distance, the DSECU 10 adjusts the deceleration of the own vehicle using a decelerating control function of the ACC so that the above-mentioned inter-vehicle distance does not become less than the permissible distance.

Next, the DSECU 10 determines, at a step S16, whether or not the own vehicle has stopped based on the vehicle speed SPD. When the own vehicle has not stopped, the DSECU 10 proceeds back to the step S15 to continue the decelerating control which is a control process to decelerate the own vehicle at the target deceleration α.

It should be noted that it is preferable that the DSECU 10 outputs a lighting instruction of the stop lamp 72 and a blinking instruction of the hazard lamp 71 to the meter ECU 70 while the decelerating control is being performed. Accordingly, the stop lamp 72 lights and the hazard lamp 71 blinks, making it possible to alert a driver of a following vehicle.

When the own vehicle has stopped by the decelerating control (S16: Yes), the DSECU 10 outputs, at a step S17, an instruction to loosen the seatbelt to the seatbelt retracting ECU 100. Thereby, the seatbelt retracting ECU 100 unlocks and loosens the seatbelt by reversely rotating the retracting motor 102 after positively rotating the retracting motor 102.

The DSECU 10 terminates the driving support control routine under the abnormal state after performing the process of the step S17. It should be noted that it is preferable that the DSECU 10 outputs an actuation instruction of the electrically-driven parking brake to the electrically-driven parking brake ECU 50 and an unlock instruction of the door lock device 91 to the body ECU 90 when the own vehicle has stopped. Accordingly, the electrically-driven parking brake is brought into an actuation state, and the door lock device 91 is brought into an unlock state. Therefore, the own vehicle can be stably maintained in the stopped state, and the driver can be rescued by opening the door. In addition, the hazard lamp 71 is preferred to continue to blink also after the own vehicle has stopped.

According to the vehicle control apparatus of the present embodiment described above, when the driver is determined to be in the abnormal state, the LKA and the decelerating control are performed in parallel under a state where the driver's posture is straightened by retracting the seatbelt. Thereby, the driver's body does not interfere with the rotation of the steering wheel SW, and therefore the steering control of the LKA can be performed properly. As a result, it is possible to make the own vehicle stop safely so that the own vehicle does not deviate from the lane.

In addition, the seatbelt can be retracted before the driver leans (falls) forward due to the deceleration of the own vehicle, and therefore the retraction of the seatbelt can be performed properly. Further, the seatbelt is loosened after the own vehicle stops. Therefore, the driver is easy to be rescued because the seatbelt has been loosened at a time of being rescued. Hence, it is possible to rescue the driver at an early timing.

### Second Embodiment

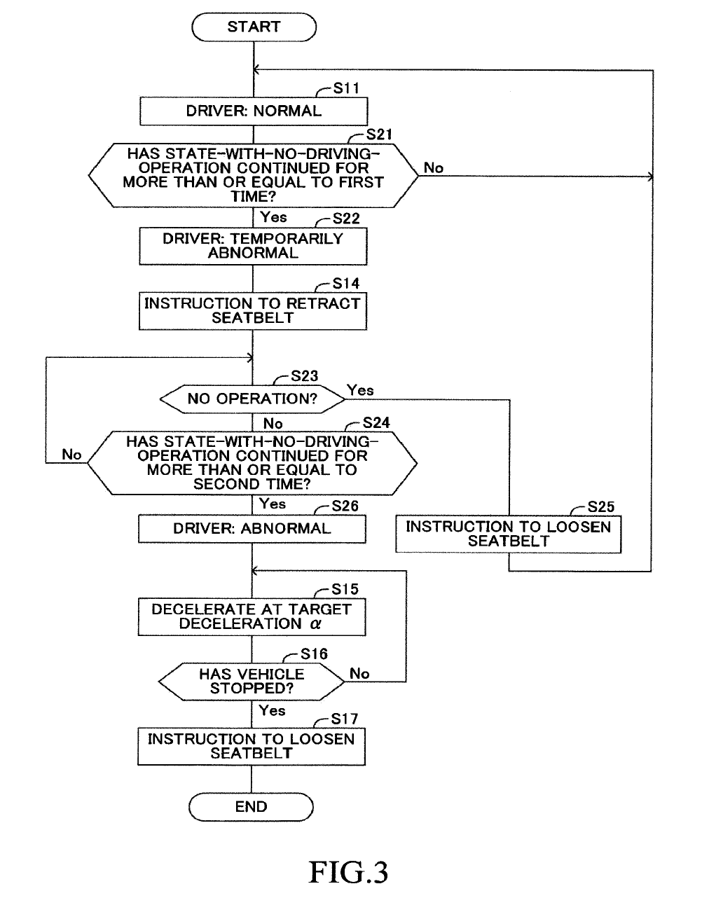

Next, a vehicle control apparatus according to the second embodiment will be described. The vehicle control apparatus of the second embodiment is different from the vehicle control apparatus of the aforementioned embodiment only in that the DSECU 10 performs a driving support control routine under an abnormal state shown in FIG. 3 in place of the aforementioned driving support control routine under the abnormal state (FIG. 2). Hereinafter, the aforementioned embodiment is referred to as a “first embodiment”.

Now, a summary of the driving support control routine under the abnormal state of the second embodiment will be described. In the first embodiment above, the seatbelt was retracted and the decelerating control of the vehicle was started at the timing at which the driver was determined to be in the abnormal state. On the other hand, in this second embodiment, the DSECU 10 retracts the seatbelt when the driver is first determined to be in the abnormal state (when the driver is temporarily determined to be in the abnormal state), and thereafter determines whether or not some driving operation is detected, taking a predetermined time.

When the predetermined time has passed without any driving operation being detected, the DSECU 10 considers the driver to be actually in the abnormal state (confirms that the driver is in the abnormal state), and starts the decelerating control of the own vehicle. On the other hand, when the driver comes back to normal (for example, the driver becomes awake by retracting the seatbelt and the like) and starts the driving operation, the DSECU 10 cancels the determination that the driver is in the abnormal state based on that driving operation, and does not perform the decelerating control of the own vehicle.

By continuing the determination of whether or not there is some driving operation even after the seatbelt is retracted as stated above, when the driver has come back to the normal state from the abnormal state, appropriate processes (that is, processes to be performed when the driver is in the normal state) can be performed. Now, one of the features in the second embodiment is that retracting the seatbelt when the driver is first determined to be in the abnormal state (at a timing of the temporary determination). In order to describe a reason for retracting the seatbelt at such a timing, hereinafter, a problem caused when the seatbelt is not retracted at the timing of the temporary determination will be stated.

For example, when the upper body of the driver who is in a weak state falls and covers the steering wheel SW after the driver has first determined to be in the abnormal state, a torque is input to the steering wheel SW. Especially, when the steering control is being performed by the LKA and the like, the steering torque is easy to be detected because the rotation of the steering wheel SW is stopped in spite of the steering motor 62 being driven. In this case, the driver is estimated to have operated the steering wheel SW. Therefore, the determination that the driver is in the abnormal state will be canceled in spite of the driver's abnormal state actually continuing.

Therefore, in the second embodiment, it is configured that the seatbelt is retracted when the driver is first determined to be in the abnormal state. Accordingly, the first determination that the driver is in the abnormal state is prevented from incorrectly canceled after retracting the seatbelt.

Hereinafter, the driving support control routine under the abnormal state of the second embodiment (FIG. 3) will be described. Regarding processes same as the processes of the first embodiment, description will be omitted or only a simple description will be made by adding the same step numbers to FIG. 3. A condition that the driving support control routine under the abnormal state in the second embodiment is performed is the same as the condition in the first embodiment.

The DSECU 10, at a step S21, measures a time during which the state-with-no-driving-operation continues, and determines whether or not the state-with-no-driving-operation has continued for more than or equal to a first time set in advance. When the duration time of the state-with-no-driving-operation is less than the first time (S21: No), the DSECU 10 proceeds back to the step S11, and therefore the driver's state is set to be “normal”. The DSECU 10 repeatedly performs the determination process of the step S21 as described above every time the predetermined calculation interval elapses.

As a result of repeating the processes above, when the duration time of the state-with-no-driving-operation has become more than or equal to the first time (S21: Yes), the DSECU 10 temporarily determines, at a step S22, that the driver is in the abnormal state. As will be described later, the determinations that the driver is in the abnormal state are performed twice, including the determination of the step S22. The determination of the step S22 is the first determination. This determination is called the temporary determination, and a driver's state at this time is called “temporarily abnormal”. The first time corresponds to a temporary abnormality determination time of the present invention.

It should be noted that the DSECU 10 may raise a warning to urge the driver to perform some driving operation in the midst of measuring the duration time of the state-with-no-driving-operation at the step S21. The DSECU 10 may make the temporary determination that the driver is in the abnormal state when the duration time of the state-with-no-driving-operation has become more than or equal to the first time in spite of raising the warning. For example, the DSECU 10 outputs a no-driving-operation warning instruction to the warning ECU 80 when the duration time of the state-with-no-driving-operation has reached a warning start time which is set to be shorter than the first time. Accordingly, the warning ECU 80 makes a warning sound from the buzzer 81, makes a warning lamp blink on the indicator 82, and displays a warning message urging the driver to operate any one of “the accelerator pedal 11a, the brake pedal 12a, and the steering wheel SW”.

When the driver makes the temporary determination that the driver is in the abnormal state, the DSECU 10, at the step S14, outputs the instruction to retract the seatbelt to the seatbelt retracting ECU 100. Thereby, the seatbelt of the driver's seat is retracted.

Subsequently, the DSECU 10 determines, at a step S23, whether or not any driving operation is not detected, that is, whether or not a state is the state-with-no-driving-operation. When a state is the state-with-no-driving-operation, the DSECU 10 proceeds to a step S24 to determine whether or not the state-with-no-driving-operation has continued for more than or equal to a second time which is a threshold value set in advance. The duration time of the state-with-no-driving-operation used in the step S24 may be a duration time after the temporary determination is made, or may be a duration time including the duration time of the state-with-no-driving-operation measured at the step S21.

When the duration time of the state-with-no-driving-operation is less than the second time (S24: No), the DSECU 10 proceeds back to the step S23. The DSECU 10 repeatedly performs the processes of the steps S23 and S24 as stated above every time the predetermined calculation interval elapses. In this situation, the driver's state determined by the DSECU 10 is maintained as “temporarily abnormal”.

When some driving operation is detected (S23: Yes) before the duration time of the state-with-no-driving-operation reaches the second time, the DSECU 10 proceeds to a step S25, and outputs an instruction to loosen the seatbelt to the seatbelt retracting ECU 100. Accordingly, the seatbelt of the driver's seat is loosened. Subsequently, the DSECU 10 proceeds to the step S11. Therefore, the temporary determination that the driver is in the abnormal state is canceled and the driver's state is set to “normal”.

For example, there is a case that the driver who had been in a drowsy state becomes awake by retracting the seatbelt and resumes the driving operation. In such a case, the temporary determination that the driver is in the abnormal state is canceled.

Besides, the determination at the step S23 is performed under a state where the seatbelt has been retracted, and therefore this determination is not performed under a state where the upper body of the driver who is in a weak state falls and covers the steering wheel SW. Thus, when the operation of the steering wheel SW has been detected at the step S23, it is possible to correctly estimate that the operation detected is the steering operation by the driver. Therefore, the accuracy of the abnormality determination of the driver can be improved.

When the duration time of the state-with-no-driving-operation has reached the second time (S24: Yes), the DSECU 10 proceeds to a step S26 to confirm the determination that the driver is in the abnormal state. Accordingly, the driver's state determined by the DSECU 10 switches from “temporarily abnormal” to “abnormal”. Subsequently, the DSECU 10 proceeds to the step S15 to stop the ACC and decelerate the own vehicle at the constant target deceleration a set in advance. Thereby, the decelerating control is performed in parallel with the LKA. Thereafter, when the own vehicle stops (S16: Yes), the DSECU 10 outputs, at the step S17, the instruction to loosen the seatbelt to the seatbelt retracting ECU 100. Accordingly, the seatbelt of the driver's seat is loosened.

According to the vehicle control apparatus of the second embodiment described above, the seatbelt is retracted when the driver is first (temporarily) determined to be in the abnormal state, and also thereafter, the determination whether or not the state-with-no-driving-operation continues is repeated. Therefore, when the driver has come back to the normal state from the abnormal state in the midst of the determination, it is possible to cancel the determination that the driver is in the abnormal state so that the decelerating control will not be started. Thus, the vehicle control appropriate to the driver's state can be performed.

Further, the determination of the step S23 whether or not the state-with-no-driving-operation continues which is performed after the driver is first (temporarily) determined to be in the abnormal state is performed under a state where the seatbelt has been retracted, that is, under a state where the driver's posture has been straightened. Therefore, an erroneous detection of the steering operation owing to the driver's upper body falling and covering the steering wheel SW is prevented, and the steering operation by the driver can be correctly detected. Thus, a problem that the determination that the driver is in the abnormal state is canceled in spite of the driver's abnormal state continuing can be prevented from occurring.

When the duration time of the state-with-no-driving-operation reaches the second time, the decelerating control of the own vehicle is started. Therefore, the own vehicle can be decelerated and stopped in accordance with the abnormality determination result with high accuracy.

Besides, as is the case with the first embodiment, the driver's body does not interfere with the rotation of the steering wheel SW, and therefore the LKA can be performed properly. Further, the seatbelt can be retracted before the driver leans forward due to the deceleration of the own vehicle, and thus the retraction of the seatbelt can be performed properly. In addition, the seatbelt is loosened after the own vehicle stops, and thus the driver is easy to be rescued.

### Third Embodiment

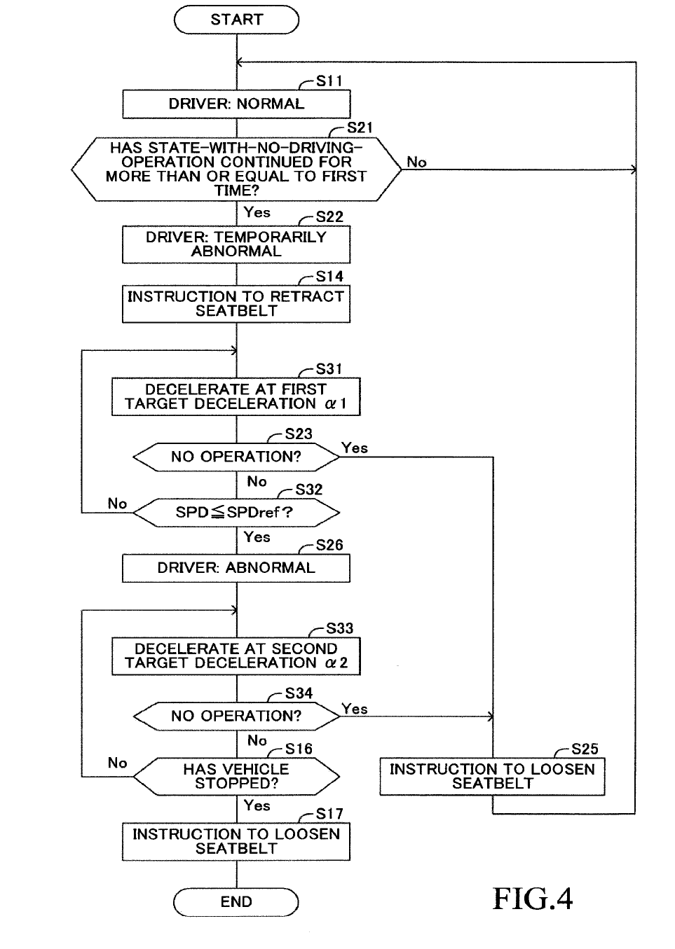

Next, a vehicle control apparatus according to the third embodiment will be described. The vehicle control apparatus of the third embodiment is different from the vehicle control apparatuses of the aforementioned first and second embodiments only in that the DSECU 10 performs a driving support control routine under an abnormal state shown in FIG. 4 in place of the aforementioned driving support control routine under the abnormal state of the first embodiment or the second embodiment.

Hereinafter, the driving support control routine under the abnormal state of the third embodiment (FIG. 4) will be described. Regarding processes same as the processes of the first and the second embodiments, description will be omitted or only a simple description will be made by adding the same step numbers to FIG. 4. A condition that the driving support control routine under the abnormal state in the third embodiment is performed is the same as the conditions in the first and second embodiments.

The DSECU 10 measures a time during which the state-with-no-driving-operation continues. The DSECU 10 sets the driver's state to “normal” (S11) while the state-with-no-driving-operation does not continue for more than or equal to the first time (S21: No), and makes the temporary determination that the driver is in the abnormal state when the state-with-no-driving-operation has continued for more than or equal to the first time (S21: Yes).

By this temporary determination, the DSECU 10 outputs, at the step S14, an instruction to retract the seatbelt of the driver's seat to the seatbelt retracting ECU 100. The processes up to the step S22 are similar to the processes in the second embodiment.

Subsequently, the DSECU 10, at a step S31, stops the ACC and decelerates the own vehicle at a constant first target deceleration α1 set in advance. In this case, the DSECU 10 outputs to the engine ECU 30 and the brake ECU 40 an instruction signal for matching the acceleration of the own vehicle with the first target deceleration α1. Accordingly, the own vehicle can be decelerated at the constant first target deceleration α1. It is preferable that this first target deceleration α1 is set to be a very moderate deceleration (a deceleration, an absolute value thereof is small). It should be noted that the decelerating control at the step S31 may be started after the retraction of the seatbelt has been finished (for example, may be started after a time needed to retract the seatbelt has elapsed), or may be started before the retraction of the seatbelt has finished. Alternatively, the DSECU 10 may outputs the instruction to retract the seatbelt to the seatbelt retracting ECU 100 right after the deceleration control at the first target deceleration α1 is started.

Subsequently, the DSECU 10 determines, at the step S23, whether or not any driving operation is not detected, or whether or not a state is the state-with-no-driving-operation. When a state is the state-with-no-driving-operation, the DSECU 10 determines, at a step S32, whether or not the vehicle speed SPD is less than or equal to a vehicle speed threshold SPDref set in advance.

When the vehicle speed SPD exceeds the vehicle speed threshold SPDref (S32: No), the DSECU 10 proceeds back to the step S31. In this way, the DSECU 10 repeatedly performs the processes of the steps S31, S23, and S32 every time the predetermined calculation interval elapses. Therefore, the decelerating control at the first target deceleration α1 continues until the vehicle speed SPD decreases to the vehicle speed threshold SPDref as long as some driving operation is not detected. In this situation, the driver's state determined by the DSECU 10 is maintained as “temporarily abnormal”.

When some driving operation has been detected (S23: Yes) before the vehicle speed SPD reaches the vehicle speed threshold SPDref, the DSECU 10 proceeds to the step S 25 to output the instruction to loosen the seatbelt to the seatbelt retracting ECU 100. Thereby, the seatbelt of the driver's seat is loosened. Subsequently, the DSECU 10 proceeds to the step S11. As a result, the temporary determination that the driver is in the abnormal state is canceled, and the driver's state is set to “normal”.

For example, there is a case that the driver who had been in a drowsy state becomes awake by retracting the seatbelt. In this case, the driving operation by the driver is resumed, and the temporary determination that the driver is in the abnormal state is canceled. Besides, it is possible to urge the driver to perform a driving operation (an acceleration operation) by the deceleration of the own vehicle which the driver does not desire. Accordingly, whether or not the driver is in the abnormal state can be confirmed.

When the vehicle speed SPD decreases to the vehicle speed threshold SPDref (S32: Yes) without any driving operation being detected, the DSECU 10 confirms, at the step S26, the determination that the driver is in the abnormal state, and proceeds to a step S33. The DSECU 10, at the step S33, switches the target deceleration from the first target deceleration α1 to a second target deceleration α2 (α1 to α2) to decelerate the own vehicle. This second target deceleration α2 is set to be a value, an absolute value thereof is greater than the absolute value of the first target deceleration α1.

Subsequently, the DSECU 10 determines, at a step S34, whether or not any driving operation is not detected, or whether or not a state is the state-with-no-driving-operation. When a state is the state-with-no-driving-operation, the DSECU 10 determines, at the step S16, whether or not the own vehicle has stopped. The DSECU 10 repeats the determinations of the steps S34 and S16, decelerating the own vehicle at the second target deceleration α2, and when some driving operation has been detected (S34: Yes) before the own vehicle stops, the DSECU 10 loosens the seatbelt of the driver's seat (S25), and cancels the determination that the driver is in the abnormal state (S11).

On the other hand, when the own vehicle has stopped (S16: Yes) without any driving operation being detected, the DSECU 10 outputs, at the step S17, the instruction to loosen the seatbelt to the seatbelt retracting ECU 100.

According to the vehicle control apparatus of the third embodiment described above, when the driver is first (temporarily) determined to be in the abnormal state, the seatbelt is retracted, and the own vehicle is decelerated at the first target deceleration α1 under a state in which the seatbelt is retracted. Therefore, the own vehicle can be decelerated to a safe speed at an early timing. The determination whether or not a state is the state-with-no-driving-operation (that is, the determination whether or not the state-with-no-driving-operation continues) is repeated also during the deceleration, and when the driver comes back to the normal state from the abnormal state in the midst of the determination, the temporary determination is canceled and the decelerating control is stopped. Therefore, the vehicle control appropriate to the driver's state can be performed. Besides, it is possible to urge the driver to perform some driving operation by decelerating the own vehicle.

Further, the determinations of the steps S23 and S34 whether or not the state-with-no-driving-operation continues which is performed after the driver is first (temporarily) determined to be in the abnormal state is performed under a state where the seatbelt has been retracted, that is, under a state where the driver's posture has been straightened. Therefore, an erroneous detection of the steering operation owing to the driver's upper body falling and covering the steering wheel SW is prevented, and the steering operation by the driver can be correctly detected. Thus, a problem that the determination that the driver is in the abnormal state is canceled in spite of the driver's abnormal state continuing can be prevented from occurring.

When the vehicle speed SPD decreases to the vehicle speed threshold SPDref with the state-with-no-driving-operation maintained, the own vehicle is decelerated at the second target deceleration α2, the absolute value thereof is greater than the absolute value of the first target deceleration α1 . Therefore, it is possible to stop the own vehicle at a safe place (in this example, the central position of the lane) early at a stage where the accuracy of the abnormality determination is increased. Besides, the LKA can be performed properly by retracting the seatbelt. Further, the retraction of the seatbelt is performed before the own vehicle is decelerated at the first target deceleration α1, or right after the deceleration at the first target deceleration α1 is started. Therefore, the seatbelt can be retracted before the own vehicle is decelerated at the second target deceleration α2, and therefore the retraction of the seatbelt can be performed properly.

The vehicle control apparatuses according to the first, second, and third embodiments have been described. However, the present invention is not limited to the aforementioned embodiments and may adopt various modifications within a scope of the present invention.

For example, in the present (first) embodiment, when the abnormal state of the driver is detected, the steering control is performed in such a manner that the own vehicle travels along the central position of the lane by means of the LKA. However, the LKA may be switched to other steering controls. For example, when the determination that the driver is abnormal is confirmed, a retreating place such as an edge of a road may be extracted from an image photographed by the camera apparatus 17b, and a target traveling line for making the own vehicle stop at the retreating place may be determined. Thereafter, a steering control amount for making the own vehicle travel along the target traveling line may be calculated, and the steering of the steering wheel may be controlled based on the calculated steering control amount.

Besides, in the present embodiment, the driving support control routine under the abnormal state is performed when both of the LKA and the ACC are being performed. However, it is not necessarily needed that both of those controls are being performed. In this case, for example, it is preferable that the driving support control routine under the abnormal state is started under a situation where a mode in which the vehicle travels without a need of the acceleration operation by the driver is selected (for example, under a situation where the ACC is selected). Besides, for example, even though the LKA is not being performed, the steering control such as the LKA and the like may be started from when the determination that the driver is in the abnormal state is made at the step S12, or the temporary determination that the driver is in the abnormal state is made at the step S22.

In addition, in the second embodiment, the abnormality confirmation condition used in the determination of the step S24 is that “the state-with-no-driving-operation continues for more than or equal to the second time”. However, for example, the abnormality confirmation condition above may be a condition that “the vehicle speed SPD decreases to less than or equal to the vehicle speed threshold SPDref with the state-with-no-driving-operation maintained” as the step S32 of the third embodiment.

Similarly, in the third embodiment, the abnormality confirmation condition used in the determination of the step S32 is that “the vehicle speed SPD decreases to less than or equal to the vehicle speed threshold SPDref with the state-with-no-driving-operation maintained”. However, for example, the abnormality confirmation condition above may be a condition that “the state-with-no-driving-operation continues for more than or equal to the second time” as the step S24 of the second embodiment.

Further, the abnormality confirmation condition used in the determination of the step S32 in the third embodiment may be a condition that “the vehicle speed SPD decreases to less than or equal to the vehicle speed threshold SPDref, and the state-with-no-driving-operation continues for more than or equal to the second time”. In this case, if the duration time of the state-with-no-driving-operation has not reached the second time yet at a point in time at which the vehicle speed SPD has decreased to less than or equal to the vehicle speed threshold SPDref, it is preferable that the DSECU 10 is configured to make the own vehicle travel at a constant speed from that point in time (that is, to maintain the vehicle speed at that point in time). Thereby, a time for performing the abnormality determination of the driver can be securely ensured.

In addition, the processes performed while the decelerating control is being performed (the lighting of the stop lamp 72, the blinking of the hazard lamp 71, and the like) in the first embodiment may be also performed while the decelerating control in the second or the third embodiment is being performed. Further, the processes performed when the own vehicle stops (the unlocking of the door lock device 91, the blinking of the hazard lamp 71, and the like) in the first embodiment may be performed also when the own vehicle stops in the second or the third embodiment.

Besides, in the second embodiment, whether or not there is some driving operation is not determined during the decelerating control (S15 and S16). However, as is the case with the third embodiment, whether or not there is some driving operation may be determined during the decelerating control also in the second embodiment. In this case, when some driving operation is detected, the process of the step S25 may be performed. That is, even after the determination that the driver is in the abnormal state has been confirmed, whether or not there is some driving operation may be determined, and when some driving operation is detected, the determination that the driver is in the abnormal state may be canceled.

Further, in the second and the third embodiments, the temporary determination that the driver is in the abnormal state is made at the step S21 based on the duration time of the state-with-no-driving-operation. However, other determination methods and the like described in the step S12 of the first embodiment (the determination methods using the “driver monitor technique” or the confirmation button 19) may be adopted instead.

1. A vehicle control apparatus comprising;
abnormality determination means for determining whether or not a driver of a vehicle is in an abnormal state where said driver loses an ability to drive said vehicle;
steering control means for performing a steering control of said vehicle so that said vehicle travels to a target position;
driving-control-under-abnormal-state means for performing a decelerating control which is a control to decelerate said vehicle in parallel with said steering control by said steering control means in a case when said driver is determined to be in said abnormal state by said abnormality determination means; and
seatbelt retracting control means for retracting a seatbelt of said driver based on a determination that said driver is in said abnormal state.

2. A vehicle control apparatus according to claim 1, wherein,
said abnormality determination means is configured to cancel a determination that said driver is in said abnormal state in a case when an input to a steering wheel is detected after said driver is determined to be in said abnormal state.

3. A vehicle control apparatus according to claim 1, wherein,
said abnormality determination means is configured to;
make a temporary determination that said driver is in said abnormal state when a state-with-no-driving-operation in which any driving operation by said driver is not detected continues for more than or equal to a temporary abnormality determination time; and
cancel said temporary determination when a driving operation by said driver is detected after said temporary determination is made, while confirm a determination that said driver is in said abnormal state when said state-with-no-driving-operation has continued until an abnormality confirmation condition set in advance is satisfied without said temporary determination being canceled,
said seatbelt retracting control means is configured to retract said seatbelt of said driver based on said temporary determination that said driver is in said abnormal state, and
said driving-control-under-abnormal-state means is configured to decelerate said vehicle after said determination that said driver is in said abnormal state is confirmed.

4. A vehicle control apparatus according to claim 1, wherein,
said abnormality determination means is configured to;
make a temporary determination that said driver is in said abnormal state when a state-with-no-driving-operation in which any driving operation by said driver is not detected continues for more than or equal to a temporary abnormality determination time; and
cancel said temporary determination when a driving operation by said driver is detected after said temporary determination is made, while confirm a determination that said driver is in said abnormal state when said state-with-no-driving-operation has continued until an abnormality confirmation condition set in advance is satisfied without said temporary determination being canceled,
said seatbelt retracting control means is configured to retract said seatbelt of said driver based on said temporary determination that said driver is in said abnormal state, and
said driving-control-under-abnormal-state means is configured to;
decelerate said vehicle at a first target deceleration when said temporary determination that said driver is in said abnormal state is made; and
switch a target deceleration of said vehicle to a second target deceleration, an absolute value of which is greater than an absolute value of said first target deceleration to decelerate said vehicle at said second target deceleration when said determination that said driver is in said abnormal state is confirmed.

5. A vehicle control apparatus according to claim 1 further comprising;
seatbelt loosening control means for loosening said retracted seatbelt when said vehicle is made to stop by said driving-control-under-abnormal-state means.

6. A vehicle control apparatus according to claim 2, wherein,
said abnormality determination means is configured to;
make a temporary determination that said driver is in said abnormal state when a state-with-no-driving-operation in which any driving operation by said driver is not detected continues for more than or equal to a temporary abnormality determination time; and
cancel said temporary determination when a driving operation by said driver is detected after said temporary determination is made, while confirm a determination that said driver is in said abnormal state when said state-with-no-driving-operation has continued until an abnormality confirmation condition set in advance is satisfied without said temporary determination being canceled,
said seatbelt retracting control means is configured to retract said seatbelt of said driver based on said temporary determination that said driver is in said abnormal state, and
said driving-control-under-abnormal-state means is configured to decelerate said vehicle after said determination that said driver is in said abnormal state is confirmed.

7. A vehicle control apparatus according to claim 6 further comprising;
seatbelt loosening control means for loosening said retracted seatbelt when said vehicle is made to stop by said driving-control-under-abnormal-state means.

8. A vehicle control apparatus according to claim 2, wherein,
said abnormality determination means is configured to;
make a temporary determination that said driver is in said abnormal state when a state-with-no-driving-operation in which any driving operation by said driver is not detected continues for more than or equal to a temporary abnormality determination time; and
cancel said temporary determination when a driving operation by said driver is detected after said temporary determination is made, while confirm a determination that said driver is in said abnormal state when said state-with-no-driving-operation has continued until an abnormality confirmation condition set in advance is satisfied without said temporary determination being canceled,
said seatbelt retracting control means is configured to retract said seatbelt of said driver based on said temporary determination that said driver is in said abnormal state, and
said driving-control-under-abnormal-state means is configured to;
decelerate said vehicle at a first target deceleration when said temporary determination that said driver is in said abnormal state is made; and
switch a target deceleration of said vehicle to a second target deceleration, an absolute value of which is greater than an absolute value of said first target deceleration to decelerate said vehicle at said second target deceleration when said determination that said driver is in said abnormal state is confirmed.

9. A vehicle control apparatus according to claim 8 further comprising;
seatbelt loosening control means for loosening said retracted seatbelt when said vehicle is made to stop by said driving-control-under-abnormal-state means.
